(19) United States
(12) Patent Application Publication
(10) Pub. No.: US 2010/0064072 A1
(43) Pub. Date: Mar. 11, 2010

(54) Dynamically Adjustable Arbitration Scheme

(75) Inventors: John Sui-kei Tang, Costa Mesa, CA (US); Sam Shan-Jan Su, Costa Mesa, CA (US); Michael Yu Liu, Costa Mesa, CA (US); Daming Jin, Costa Mesa, CA (US)

Correspondence Address: EMULEX DESIGN & MANUFACTURING CORPORATION;C/O MORRISON & FOERSTER LLP, 555 WEST FIFTH STREET, SUITE 3500, LOS ANGELES, CA, 90013, US

(73) Assignee: Emulex Design & Manufacturing Corporation, Costa Mesa, CA (US)

(21) Appl. No.: 12/207,380

(22) Filed: Sep. 9, 2008

(51) Int. Cl. G06F 13/28

(52) U.S. Cl. 710/39

(57) ABSTRACT

A network arbitration scheme is disclosed that manages device access fairness by selectively and dynamically increasing a requestor queue's likelihood of being serviced. A requestor queue increases its service priority by duplicating a request entry onto a set of priority rings maintained by arbitration hardware in a host bus adapter. Duplication occurs when (1) a requestor's queue fill count (the number of descriptors stored in the queue) exceeds a watermark level or (2) a requestor's queue timer times out. In the case of time-out, the requester in the lower priority ring will duplicate itself in the higher priority ring. Because the arbitration hardware services requesters using a round robin selection scheme, the likelihood of a requestor queue being serviced increases as the number of its duplicate request entries on a priority ring increases. Upon being serviced, the requester is able to perform the requested action.

### FIELD OF THE INVENTION

The present invention relates generally to device access fairness and, in particular embodiments, to device access fairness in a storage network environment.

### BACKGROUND OF THE INVENTION

FIG. 1 illustrates an exemplary storage area network (SAN) that can allow remote computer devices 102 to connect to servers 104 such that these devices appear locally attached. Sharing storage resources over a SAN fabric 106 provides users with many benefits, including the flexibility to transfer data from one server to another without a physical move, as well as the development of more effective disaster recovery processes. Many SANs utilize a Fibre Channel (FC) fabric topology to control how devices in the fabric are connected. Although FC connections provide fast and reliable access, the growing presence of the Internet foreshadows a shift from a FC-centric topology to a solution capable of accommodating both FC and Internet traffic.

One way to implement this hybrid topology is to transmit FC traffic wrapped in Internet packets over a combination of FC and network interface card (NIC) links. However, this solution is problematic. FC frames are typically much larger that NIC packets (2000 bytes v. 256 bytes on average). Under a conventional fair arbitration scheme, FC requestors and NIC requesters are serviced on an alternating basis. Because FC frames are substantially larger than NIC packets and, consequently, pose greater network demands, FC traffic will have more throughput than NIC traffic. This situation creates a FC-heavy network that compromises the NIC's 10 gigabyte link speed. In order to preserve the NIC link speed, a dynamically adjustable arbitration scheme needs to be developed that can guarantee bandwidth for both NIC and FC traffic.

### SUMMARY OF THE INVENTION

Embodiments of the present invention are directed to a network arbitration scheme that manages device access fairness by selectively and dynamically increasing a requestor queue's likelihood of being serviced. A requestor queue increases its service priority by duplicating a request entry onto a set of priority rings maintained by arbitration hardware in a host bus adapter. Duplication occurs when (1) a requestor's queue fill count (the number of descriptors stored in the queue) exceeds a watermark level or (2) a requestor's queue timer times out. In the case of time-out, the requester in the lower priority ring will duplicate itself in the higher priority ring. Because the arbitration hardware services requestors using a round robin selection scheme, the likelihood of a requestor queue being serviced increases as the number of its duplicate request entries on a priority ring increases. Upon being serviced, the requestor is able to perform the requested action, such as retrieving data from the host memory and storing it in local memory for eventual transmission over a network.

### BRIEF DESCRIPTION OF THE DRAWINGS

FIG. 1 illustrates an exemplary SAN comprised of remotely connected servers and computer devices.

FIG. 2 illustrates an exemplary server with a driver, local memory block, host bus adapter (HBA), direct memory access (DMA) transfer and receive engines, requestor queues, and arbitration hardware.

FIG. 3 illustrates an exemplary queue with sixteen descriptors, a read pointer, a write pointer, a watermark level, and a timer according to embodiments of the invention.

FIG. 4 illustrates an exemplary embodiment of the arbitration hardware comprising three separate priority rings, each with sixteen requestor slots according to embodiments of the invention.

FIG. 5 illustrates exemplary request entry duplication in a ring with vacant slots according to embodiments of the invention.

FIG. 6 illustrates exemplary request entry duplication when the normal priority ring is completely filled and the high priority ring has vacant slots according to embodiments of the invention.

FIG. 7a illustrates exemplary requester service for a normal priority ring when there are no request entry duplicates according to embodiments of the invention.

FIG. 7b illustrates requester service for a high priority ring when there are no request entry duplicates according to embodiments of the invention.

FIG. 8 illustrates exemplary requestor service when the normal priority ring is completely filled and the high priority ring has vacant slots according to embodiments of the invention.

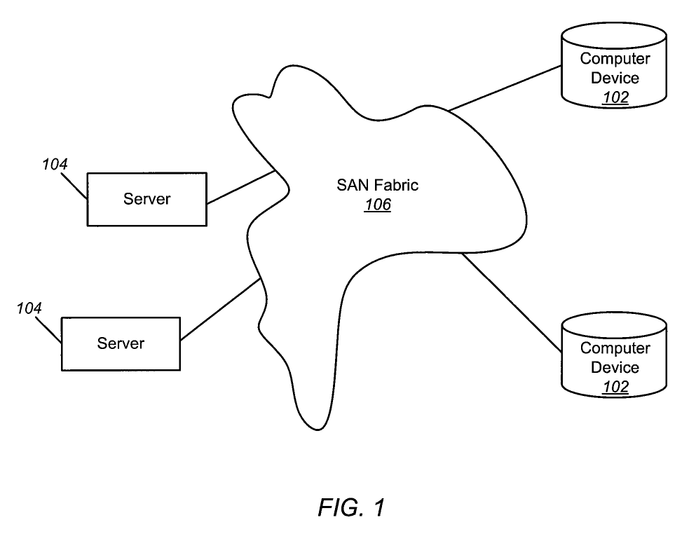

### DETAILED DESCRIPTION OF THE PREFERRED EMBODIMENT

In the following description of preferred embodiments, reference is made to the accompanying drawings in which it is shown by way of illustration specific embodiments in which the invention can be practiced. It is to be understood that other embodiments can be used and structural changes can be made without departing from the scope of the embodiments of this invention.

Embodiments of the present invention are directed to a network arbitration scheme that manages device access fairness by selectively and dynamically increasing a requester queue's likelihood of being serviced. A requestor queue increases its service priority by duplicating a request entry onto a set of priority rings maintained by arbitration hardware in a host bus adapter. Duplication occurs when (1) a requestor's queue fill count (the number of descriptors stored in the queue) exceeds a watermark level or (2) a requestor's queue timer times out. In the case of time-out, the requester in the lower priority ring will duplicate itself in the higher priority ring. Because the arbitration hardware services requestors using a round robin selection scheme, the likelihood of a requestor queue being serviced increases as the number of its duplicate request entries on a priority ring increases. Upon being serviced, the requestor is able to perform the requested action, such as retrieving data from the host memory and storing it in local memory for eventual transmission over a network.

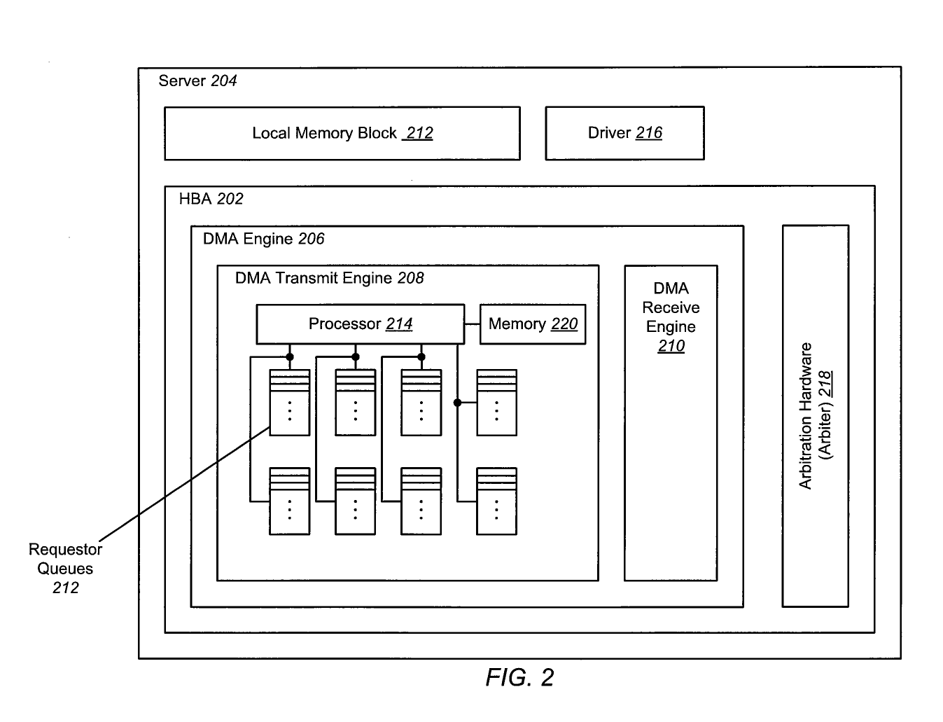

FIG. 2 depicts an exemplary host bus adapter (HBA) 202, a local memory block 212, and a driver 216 inside a server 204 according to embodiments of the invention. Inside the HBA is arbitration hardware (arbiter) 218 and a direct memory access (DMA) engine 206, a hardware resource that transfers data from a source location to a specified destination. The DMA engine is composed of a transmit engine 208 and a receive engine 210. Inside the DMA transmit engine 208 is a processor 214, memory 220, and a series of data transmission links that can accommodate different types of traffic. In some embodiments, these links are FC links and NIC links. Each link is connected to a pair of requestor queues 212 that reside in the DMA transfer engine 208. According to embodiments of the invention, each link has a normal and high priority requester queue 212. Although not shown in FIG. 2 for purposes of simplifying the figure, the DMA receive engine 210 also has a processor and a number of requestor queues.

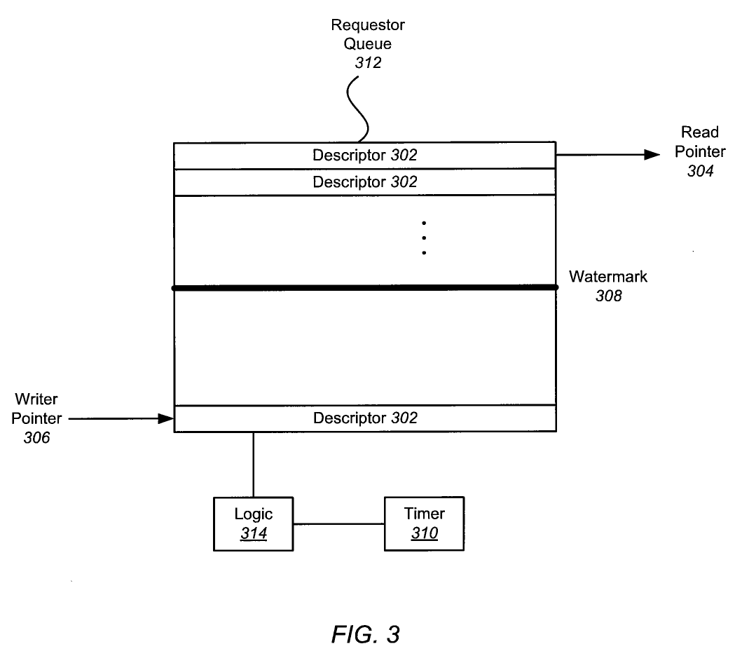

FIG. 3 depicts one exemplary embodiment where each queue 312 possesses sixteen descriptor slots, a read pointer 304, a write pointer 306, a watermark 308, timer 310, and logic 314 according to embodiments of the invention. When the driver in the server wants to transmit data (e.g., a write command) from the server to a destination device through a particular link, the driver sends a command which is received and interpreted by firmware within the HBA (host bus adapter), which in turn programs the DMA transmit engine by writing a descriptor 302 to the particular requestor queue 312 associated with the desired link at the location of the write pointer 306 for that requester queue. The descriptor 302 contains the information needed to effect this data transfer. This information includes, but is not limited to, a host memory address, host memory byte count, local memory address, and local memory byte count. The watermark 308 and timer 310 are programmable parameters that independently determine whether request entry duplication can occur. A similar process occurs when the driver in the server wants to receive data (e.g., a read command) from a destination device to the server through a particular link.

When a requestor queue requests service, it sends a request entry to the arbitration hardware (arbiter) in the HBA. Depending on the requestor's queue fill count, watermark level 308, and timer value 310, the request entry may be duplicated within the same priority ring or the next higher priority ring maintained by the arbitration hardware to increase the likelihood of being serviced. The queue, rather than the arbiter, decides whether to duplicate one or more request entries. Independent of the duplication process, arbitration hardware utilizes one or more priority rings to determine which requestor queue to service. Both request entry duplication and requester service are described below.

A requester queue can duplicate a request entry one or more times on a priority ring to increase the requestor queue's service priority. Duplication occurs when (1) the number of descriptors in a requestor queue (the queue fill count) exceeds the programmable watermark level; or (2) the requestor's queue timer times out in which case the duplicate entry is made in the higher priority ring. Both a requestor's queue watermark level and time out value are programmable. Request entry duplication is disabled when either the requestor's queue watermark level is set to zero or when the requestor's queue timer is set to zero. Both request entry duplication preconditions are checked by logic 314 in the requestor queue at the beginning of each arbitration cycle.

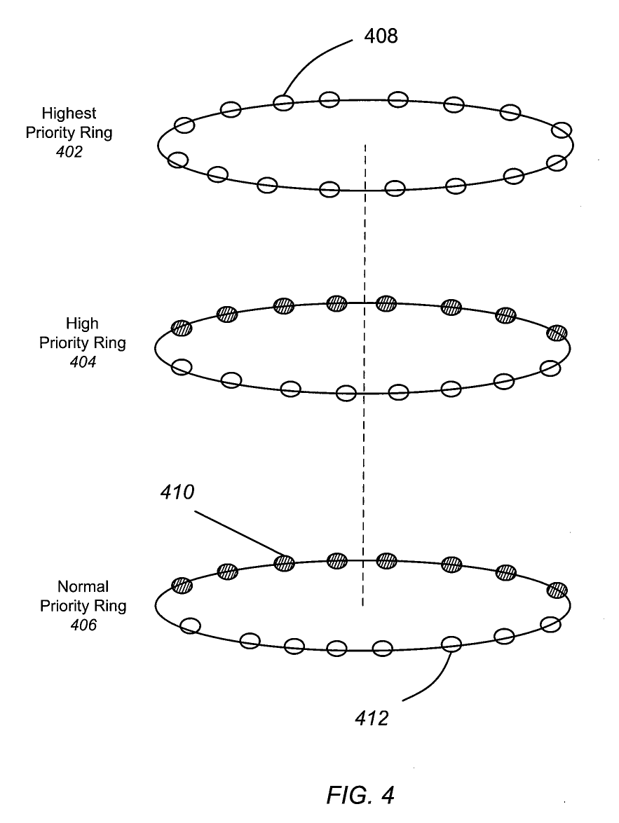

FIG. 4 illustrates one exemplary embodiment of the invention in which request entry duplication occurs on three separate priority rings maintained by the arbiter—a normal priority ring 406, high priority ring 404, and highest priority ring 402, although it should be understood that any number of priority rings may be maintained, each priority ring representing a different level of priority. In the example of FIG. 4, each priority ring contains sixteen requester slots 408. Each requestor slot is either prededicated 410 or vacant 412. In the normal and high priority rings, the number of prededicated slots 410 is equal to the number of requestor queues. For example, assume there are four links attached to the HBA. Because each link has a normal and high priority requester queue, there are eight total requestor queues. Of the sixteen slots in a given normal or high priority ring, eight slots are prededicated for these requestor queues. The remaining eight slots are vacant and can be filled with duplicate request entries.

When a requester queue is not empty, it places a request entry into its prededicated slot in a priority ring. Depending on the priority of the descriptor, the requester queue may place a request entry into either its prededicated slot in the normal priority queue or the high priority queue. Because most arbitration issues are resolved either at the normal 406 or high 404 priority ring levels, the highest priority ring 402 may be rarely used. Instead, the highest priority ring 402 can be reserved for debugging purposes. When a requestor requires debugging, it bypasses the arbitration hardware and writes itself directly into the highest priority ring in the DMA engine.

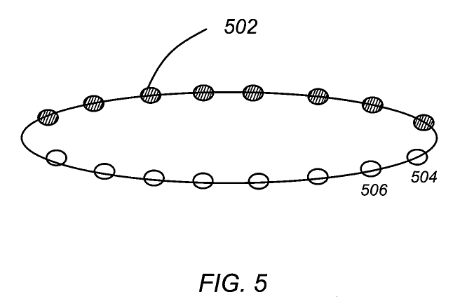

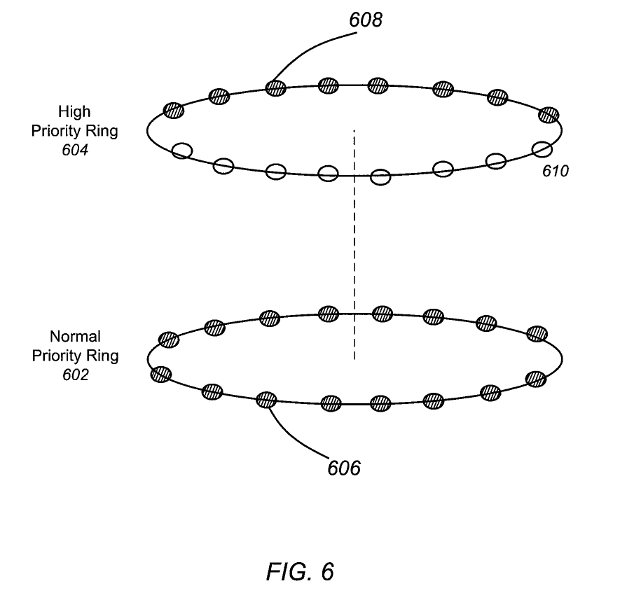

Duplication occurs in the first vacant spot in the lowest priority ring available. In the high priority ring, each requestor is guaranteed only one duplicate request entry. Thus, each requestor can duplicate its request entry only once in the high priority ring. Duplication in the normal priority ring is not restricted. FIG. 5 and FIG. 6 are provided as examples to illustrate how duplication occurs.

FIG. 5 illustrates request entry duplication in a normal priority ring with vacant slots according to embodiments of the invention. Assume that the preconditions for duplication are satisfied. Duplication occurs in the first vacant spot in the lowest priority ring available. Because the first eight slots are prededicated 502, request entry duplication occurs in slot 504. At the beginning of the next arbitration cycle, the preconditions for duplication are checked by each requestor queue. If the queue depth exceeds the watermark, then duplication will recur in the first available slot. Because slot 504 is already occupied, the duplicate request entry will be placed in slot 506. If the queue timer has timed out, then duplication will occur in the higher priority ring.

FIG. 6 illustrates request entry duplication when the normal priority ring 602 is completely filled and the high priority ring 604 has vacant slots according to embodiments of the invention. Assume that the preconditions for duplication are satisfied, and that all slots 606 in the normal priority ring 602 are filled. Duplication occurs in the first vacant spot in the lowest priority ring available. Because the normal priority ring 602 is full, duplication occurs in the high priority ring 604. In the high priority ring 604, slots 608 are prededicated. Thus, duplication occurs at slot 610, the first available slot.

When a requestor queue requests service, it sends a request to the arbitration hardware (arbiter). The arbiter determines which requestor to service. This process is independent of and happens concurrently with request entry duplication. Higher priority rings are serviced before lower priority rings. Within each ring, request entries are serviced on a round robin basis. The arbiter communicates its selection to the corresponding requester queue in the DMA transfer engine through a “grant”. Upon receiving the “grant” from the arbiter, the queue issues a “valid descriptor” to the DMA transmit engine, which in turn, executes the command specified by the descriptor in the queue as defined by the read pointer. The arbiter moves to a lower priority ring when all request entries in the higher priority ring are serviced. After a request entry is serviced, three events occur. First, the hardware read pointer is modified to point to the next descriptor in the queue. Second, if the queue's fill count falls below the water-mark, all additional instantiations of the duplicate request entry in any of the priority rings, if any, are eliminated by the queue. Third, if the queue has been granted by the arbiter, the timer associated with that particular queue is reset to the user specified value, if any, so long as there is at least one unserviced descriptor in the requester queue (as determined by the position of the read and write pointers). If there are no unserviced descriptors in the requestor queue, the timer is disabled.

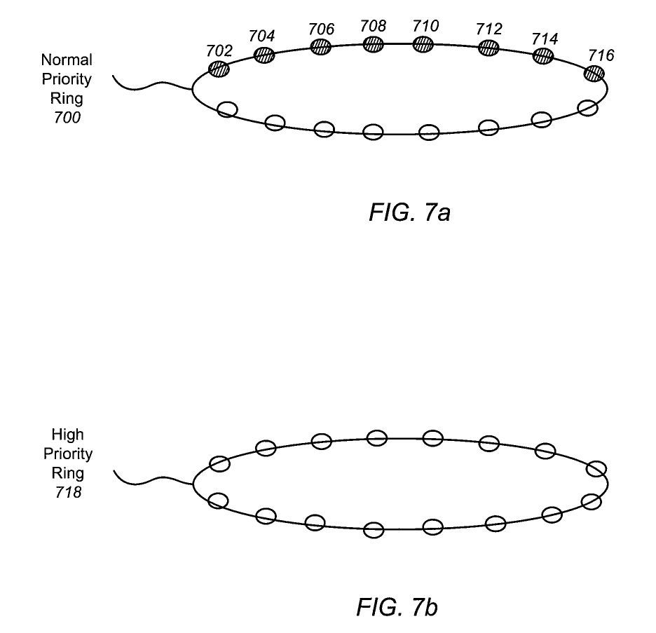

FIG. 7a illustrates exemplary requestor service for a normal priority ring 700 when there are no request entry duplicates according to embodiments of the invention. In this scenario, each requestor queue can fill only one of the eight prededicated slots 702-716 with a request entry when it contains a descriptor. The arbiter services each requestor on a round robin basis. The arbiter services the request entry (if any) in slot 702, followed by the request entry (if any) in slot 704, and so on through slot 716. Because there are no duplicates to service, the arbiter circles back to slot 702 after servicing the request entry (if any) in slot 716.

FIG. 7b illustrates requestor service for a high priority ring 718 when there are no request entry duplicates according to embodiments of the invention. In this scenario, each requestor queue can fill only one of the eight prededicated slots 702-716 with a request entry when it contains a descriptor. The arbiter services each requestor on a round robin basis. The arbiter services the request entry (if any) in slot 702, followed by the request entry (if any) in slot 704, and so on through slot 716. Because there are no duplicates to service, the arbiter circles back to slot 702 after servicing the request entry (if any) in slot 716.

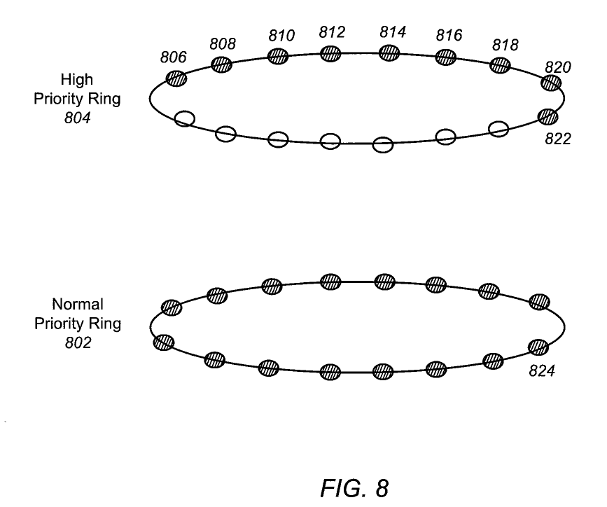

FIG. 8 illustrates a full normal priority ring 802 and a partially filled high priority ring 804. Assume that the duplicates in slots 822 and 824 stem from the same requestor queue. Because higher priority rings are serviced before lower priority rings, the arbiter circles through the high priority ring 804 first in a round robin fashion. In the high priority ring 804, the arbiter services the request entry in slot 806, followed by the request entry in slot 808, and so on through slot 822. After the arbiter services the request entry in slot 822, there are no more duplicate request entries to service in the high priority ring 804; only empty prededicated slots remain. Consequently, the arbiter moves to the normal priority ring 802 to determine which request entry to service next, and the duplicate request entries in slots 822 and 824 are removed. In addition, in the requestor queue the hardware read pointer is moved to the next descriptor (if any), and the timer is reset if there is another descriptor in the requester queue.

Although embodiments of this invention have been fully described with reference to the accompanying drawings, it is to be noted that various changes and modifications will become apparent to those skilled in the art. Such changes and modifications are to be understood as being included within the scope of embodiments of this invention as defined by the appended claims.

What is claimed is:

1. A method for managing device access fairness in a storage area network, comprising:
maintaining a plurality of requestor queues, each requester queue for storing descriptors representing access requests through a link associated with that requestor queue;
maintaining one or more priority rings, each priority ring containing a plurality of requestor slots for storing request entries from the requestor queues and managing device access fairness;
measuring a queue fill count of a particular requestor queue and comparing it to a watermark level; and
duplicating a request entry for the particular requestor queue on a priority ring if the queue depth exceeds the watermark level.

2. The method as recited in claim 1, further comprising:
maintaining a timer associated with particular requestor queue; and
duplicating a request entry for the particular requestor queue on a higher priority ring if the timer has timed out.

3. The method as recited in claim 2, wherein maintaining a timer associated with a particular requestor queue further comprises:
periodically decrementing the timer so long as the particular requestor queue contains at least one unserviced descriptor; and
determining that the timer has timed out when the timer's value is equal to zero.

4. The method as recited in claim 2, wherein duplicating a request entry for the particular requester queue on the priority ring further comprises inserting a request entry into a first vacant slot of a lowest priority ring.

5. The method as recited in claim 2, further comprising:
locating a highest priority ring containing a duplicate request entry; and
selecting request entries in the located ring for servicing in a round robin manner.

6. The method as recited in claim 5, further comprising:
servicing a selected request entry;
eliminating any additional instantiations of the serviced request entry from any of the one or more priority rings;
moving a read pointer in the requestor queue associated with the serviced request entry to another unserviced descriptor, if any; and
resetting a timer associated with the requestor queue associated with the serviced request entry to a user-specified value if there is at least one unserviced descriptor still in the requestor queue.

7. A computer-readable storage medium storing program code for managing device access fairness in a storage area network, the program code for causing performance of a method comprising:
maintaining a plurality of requestor queues, each requester queue for storing descriptors representing access requests through a link associated with that requester queue;
maintaining one or more priority rings, each priority ring containing a plurality of requestor slots for storing request entries from the requester queues and managing device access fairness;
measuring a queue fill count of a particular requestor queue and comparing it to a watermark level; and
duplicating a request entry for the particular requestor queue on a priority ring if the queue depth exceeds the watermark level.

8. The computer-readable storage medium as recited in claim 7, the program code further for causing performance of a method comprising:
maintaining a timer associated with particular requestor queue; and
duplicating a request entry for the particular requester queue on a higher priority ring if the timer has timed out.

9. The computer-readable storage medium as recited in claim 8, wherein maintaining a timer associated with a particular requester queue further comprises:
periodically decrementing the timer so long as the particular requestor queue contains at least one unserviced descriptor; and
determining that the timer has timed out when the timer's value is equal to zero.

10. The computer-readable storage medium as recited in claim 8, wherein duplicating a request entry for the particular requestor queue on the priority ring further comprises inserting a request entry into a first vacant slot of a lowest priority ring.

11. The computer-readable storage medium as recited in claim 8, the program code further for causing performance of a method comprising:
locating a highest priority ring containing a duplicate request entry; and
selecting request entries in the located ring for servicing in a round robin manner.

12. The computer-readable storage medium as recited in claim 11, the program code further for causing performance of a method comprising:
servicing a selected request entry;
eliminating any additional instantiations of the serviced request entry from any of the one or more priority rings;
moving a read pointer in the requester queue associated with the serviced request entry to another unserviced descriptor, if any; and
resetting a timer associated with the requestor queue associated with the serviced request entry to a user-specified value if there is at least one unserviced descriptor still in the requestor queue.

13. A system for managing device access fairness in a storage area network, comprising:
a plurality of requester queues, each requester queue configured for storing descriptors representing access requests through a link associated with that requestor queue;
an arbiter containing one or more priority rings, each priority ring containing a plurality of requester slots and configured for storing request entries from the requester queues and managing device access fairness; and
logic within each of the plurality of requestor queues, the logic configured for measuring a queue depth of the requestor queue, comparing the queue depth to a watermark level, and duplicating a request entry for the particular requestor queue on a priority ring if the queue depth exceeds the watermark level.

14. The system as recited in claim 13, each requestor queue further comprising a timer, and wherein the logic within each requester queue is configured for duplicating a request entry for the requester queue on a higher priority ring if the timer has timed out.

15. The system as recited in claim 14, wherein the logic within each requestor queue is further configured for:
periodically decrementing the timer so long as the requestor queue contains at least one unserviced descriptor; and
determining that the timer has timed out when the timer's value is equal to zero.

16. The system as recited in claim 14, wherein the logic within each requestor queue is further configured for inserting a request entry into a first vacant slot of a lowest priority ring.

17. The system as recited in claim 14, wherein the arbiter is configured for:
locating a highest priority ring containing a duplicate request entry; and
selecting request entries in the located ring for servicing in a round robin manner.

18. The system as recited in claim 17, the logic within each requestor queue further configured for, after servicing a selected request entry:
eliminating any additional instantiations of the serviced request entry from any of the one or more priority rings;
moving a read pointer in the requester queue associated with the serviced request entry to another unserviced descriptor, if any; and
resetting a timer associated with the requestor queue associated with the serviced request entry to a user-specified value if there is at least one unserviced descriptor still in the requester queue.

19. The system as recited in claim 13, the system incorporated into a host bus adapter (HBA).

20. The system as recited in claim 19, the HBA incorporated into a server.

21. The system as recited in claim 20, the server incorporated into a storage area network (SAN).
